(19) United States
(12) Patent Application Publication
(10) Pub. No.: US 2025/0365363 A1
(43) Pub. Date: Nov. 27, 2025

(54) ELECTRONIC DEVICE PROVIDING HANDS-FREE FUNCTIONALITY AND CONTROL METHOD THEREOF

(71) Applicant: SAMSUNG ELECTRONICS CO., LTD., Suwon-si (KR)

(72) Inventors: Minji KIM, Suwon-si (KR); Bongjun KO, Suwon-si (KR); Deoknam KIM, Suwon-si (KR); Younghoon MOON, Suwon-si (KR); Sukun YOON, Suwon-si (KR); Hojeen JEE, Suwon-si (KR)

(73) Assignee: SAMSUNG ELECTRONICS CO., LTD., Suwon-si (KR)

(21) Appl. No.: 19/275,475

(22) Filed: Jul. 21, 2025

Related U.S. Application Data
(63) Continuation of application No. PCT/KR2025/005253, filed on Apr. 17, 2025.

(30) Foreign Application Priority Data
May 27, 2024 (KR) 10-2024-0068844

(51) Int. Cl. H04M 1/72412; H04L 12/18; H04L 61/4511; H04W 8/26

(52) U.S. Cl. CPC H04M 1/72412; H04L 12/189; H04L 61/4511; H04W 8/26

(57) ABSTRACT

An electronic device includes one or more processors and memory storing instructions. The instructions, when executed by the one or more processors, cause the electronic device to receive a first Bluetooth low energy (BLE) packet including first identification information, identify a first external device based on the first identification information, transmit a second BLE packet based on the identification of the first external device as a pre-registered device, based on a connection request being received from the first external device according to the transmission of the second BLE packet, perform a first connection between the electronic device and the first external device, and execute a first hands-free functionality of controlling a first notification, intended to be output by the first external device, to be output by the electronic device, based on the first connection of the electronic device with the first external device.

### CROSS-REFERENCE TO RELATED APPLICATIONS

This application is a continuation of International Application No. PCT/KR2025/005253, filed on Apr. 17, 2025, which claims priority to Korean Patent Application No. 10-2024-0068844, filed on May 27, 2024, in the Korean Intellectual Property Office, the disclosures of which are incorporated by reference herein in their entireties.

### BACKGROUND

### 1. Field

The present disclosure relates generally to electronic devices, and more particularly, to an electronic device providing a hands-free functionality and a control method thereof.

### 2. Description of Related Art

A hands-free functionality may refer to a functionality that may allow a user of a user terminal device (e.g., a cellular phone, a mobile phone, a smart phone, a tablet computer, a laptop computer, a wearable device, a smart appliance, an Internet of Things (IoT) device, or the like) to respond to various notifications (e.g., a phone call or a short message service (SMS) message) received by the user terminal device without directly touching the user terminal device.

For example, if the user terminal device, while connected to a vehicle, receives a notification while driving, based on the hands-free functionality, the user may respond to the notification (e.g., answer and/or reject the phone call) through a voice-based interface installed in the vehicle without being distracted from the driving (e.g., moving hands away from the steering wheel).

Related art hands-free functionality may be limited to a single user terminal device connected to an electronic device (e.g., a vehicle entertainment device) and/or may provide a user interface (UI) that may only respond to notifications received by the single currently-connected user terminal device.

Thus, there exists a need for further improvements in hands-free functionality that may provide a UI capable of responding to notifications from a plurality of user terminal devices installed around the electronic device, in addition to notifications received by the user terminal device currently connected to the electronic device.

### SUMMARY

According to an aspect of the present disclosure, an electronic device includes a communication interface, one or more processors including processing circuitry, and memory storing instructions. The instructions, when executed by the one or more processors individually or collectively, cause the electronic device to receive, through the communication interface, a first Bluetooth low energy (BLE) packet including first identification information, identify a first external device based on the first identification information, transmit, through the communication interface, a second BLE packet based on the identification of the first external device as a pre-registered device, based on a connection request being received from the first external device through the communication interface according to the transmission of the second BLE packet, perform a first connection between the electronic device and the first external device, and execute a first hands-free functionality of controlling a first notification, intended to be output by the first external device, to be output by the electronic device, based on the first connection of the electronic device with the first external device.

According to an aspect of the present disclosure, a control method of an electronic device includes receiving a first BLE packet including identification information, identifying a first external device based on the identification information, transmitting, to the first external device, a second BLE packet based on identifying the first external device as a pre-registered device, based on a connection request being received from the first external device through the communication interface, according to the transmission of the second BLE packet, performing a first connection between the electronic device and the first external device, and executing a first hands-free functionality of controlling a first notification, intended to be output by the first external device, to be output by the electronic device based on the first connection of the electronic device with the first external device.

According to an aspect of the present disclosure, a non-transitory computer-readable storage medium includes a computer-readable instruction. The computer-readable instruction, when executed by at least one processor of an electronic device, causes the electronic device to receive a first BLE packet comprising identification information, identify an first external device based on the identification information, transmit a second BLE packet based on the identification of the first external device as a pre-registered device, based on a connection request being received from the first external device according to the transmission of the second BLE packet, perform a connection between the electronic device and the first external device, and execute a hands-free functionality of controlling a notification intended to be output by the first external device, to be output by the electronic device based on the connection of the electronic device with the first external device.

According to an aspect of the present disclosure, a system includes a first external device, a second external device, and an electronic device. The electronic device is configured to receive a first BLE packet including first identification information, identify the first external device based on the first identification information, transmit a second BLE packet based on the identification of the first external device as a pre-registered device, based on a connection request being received from the first external device according to the transmission of the second BLE packet, perform a first connection between the electronic device and the first external device, and execute a first hands-free functionality of controlling a first notification, intended to be output by the first external device, to be output by the electronic device, based on the first connection of the electronic device with the first external device.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a diagram for describing a hands-free functionality, according to an embodiment of the present disclosure;

FIG. 2 is a block diagram showing a configuration of a display device, according to an embodiment of the present disclosure;

FIG. 3 is a diagram for describing the display device transmitting and receiving a Bluetooth™ low energy (BLE) advertising packet to and from a user terminal device, according to an embodiment of the present disclosure;

FIG. 4 is a sequence diagram for describing the display device displaying a notification received by the user terminal device, according to an embodiment of the present disclosure.

FIG. 5 is a sequence diagram for describing a method for registering the user terminal device to the display device, according to an embodiment of the present disclosure;

FIG. 6 is a diagram for describing the display device receiving a multicast domain name system (mDNS) query from the user terminal device and transmitting an mDNS response to the user terminal device, according to an embodiment of the present disclosure;

FIG. 7 is a sequence diagram for describing the display device displaying the notification received by the user terminal device that is logged in using an account different from an account logged into the display device, according to an embodiment of the present disclosure;

FIG. 8 is a sequence diagram for describing a method for activating the hands-free functionality of the display device by using the user terminal device that is logged in using the same account as the account logged into the display device, according to an embodiment of the present disclosure;

FIG. 9 is a sequence diagram for describing a method for activating the hands-free functionality of the display device by using the user terminal device that is logged in using the account different from the account logged into the display device, according to an embodiment of the present disclosure;

FIG. 10 is a sequence diagram for describing a method for activating the hands-free functionality of the display device, according to an embodiment of the present disclosure;

FIG. 11 is a diagram for describing the display device, according to an embodiment of the present disclosure; and

FIG. 12 is a flowchart for describing a control method of a display device, according to an embodiment of the present disclosure.

### DETAILED DESCRIPTION

Hereinafter, example embodiments of the present disclosure are described in detail with reference to the accompanying drawings.

General terms currently widely used may be selected as terms used in embodiments of the present disclosure in consideration of their functions in the present disclosure, and may be changed based on the intentions of those skilled in the art or a judicial precedent, the emergence of a new technique, or the like. In addition, in a specific case, terms arbitrarily selected by an applicant may be present. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the present disclosure, an expression “have”, “may have”, “include”, “may include”, or the like may indicate the presence of a corresponding feature (e.g., a numerical value, a function, an operation, or a component such as a part), and may not exclude the presence of an additional feature.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

Expressions “first”, “second”, or the like used in the present disclosure may qualify various components regardless of the sequence or importance of the components. These expressions may be used only to distinguish one component and another component from each other, and do not limit the corresponding components.

If any component (e.g., a first component) is described as being “(operatively or communicatively) coupled with/to or connected to” another component (e.g., a second component), it should be understood that any component may be directly coupled to another component or may be coupled to another component through yet another component (e.g., a third component).

A term of a singular number may include its plural number unless explicitly indicated otherwise in the context. It should be understood that a term “include”, “formed of”, or the like used in this application specifies the presence of features, numerals, steps, operations, components, parts, or combinations thereof, mentioned in the present disclosure, and may not preclude the presence or addition of one or more other features, numerals, steps, operations, components, parts, or combinations thereof.

In the present disclosure, a “module” or a “˜er/˜or” may perform at least one function or operation, and be implemented by hardware, software, or a combination of hardware and software. In addition, a plurality of “modules” or a plurality of “˜ers/˜ors” may be integrated in at least one module to be implemented by at least one processor except for a “module” or a “˜er/or” that needs to be implemented by specific hardware.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

As used herein, a term “user” may refer to a person using an electronic device or a device using the electronic device (e.g., artificial intelligence electronic device).

Hereinafter, various embodiments of the present disclosure are described with reference to the accompanying drawings.

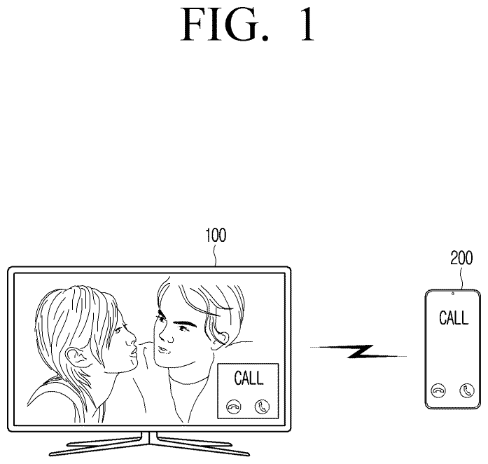

FIG. 1 is a diagram for describing a hands-free functionality, according to an embodiment of the present disclosure.

Referring to FIG. 1, an electronic device 100, according to an embodiment of the present disclosure, may communicate with a user terminal device 200 and may display a notification (or message) received by the user terminal device 200.

For example, the electronic device 100 may display a notification received by the user terminal device 200 to enable a user to recognize the received notification if the user terminal device 200, which is directly/indirectly connected to the electronic device 100 by using a wired/wireless method, receives the notification.

For example, if the user terminal device 200 receives the notification including a phone call, a message, or the like, the electronic device 100 may execute a hands-free functionality of displaying the notification received by the user terminal device 200 to enable the user to respond to the notification (e.g., answer/reject the phone call, read the message, reply to the message, or the like) without touching (or coming into physical contact with) the user terminal device 200.

A related display device may display only the notification received by one user terminal device connected to the display device from among a plurality of user terminal devices disposed around the display device, and may not be able to display a notification received by another user terminal device.

The related display device may display only the notification received by one user terminal device that is logged in using the same account as an account logged into the display device, and may not be able to display the notification received by another user terminal device that is logged in using an account different from the account logged into the display device.

According to an embodiment, the electronic device 100 may display the notification received by the user terminal device 200 that is not currently connected to the electronic device 100 and/or the user terminal device 200 that is logged in using an account different from the account currently logged into the electronic device 100.

According to an embodiment, the electronic device 100 may be implemented as a television (TV). However, the present disclosure is not limited thereto, and aspects of the present disclosure may be applied to any device having a display function, such as, but not limited to, a video wall, a large format display (LFD), a digital signage, a digital information display (DID), a projector display, or the like. In addition, the electronic device 100 may be implemented in any of various types of displays such as, but not limited to, a liquid crystal display (LCD), an organic light-emitting diode (OLED), a liquid crystal on silicon (LCoS), a digital light processing (DLP), a quantum dot display panel (QD), quantum dot light-emitting diodes (QLED), micro light-emitting diodes (μLED), mini light-emitting diodes (Mini LED), or the like.

According to an embodiment, the user terminal device 200 may be implemented as any of various types of external devices such as, but not limited to, a TV, a personal computer (PC), a laptop PC, a mobile phone, a tablet PC, a personal digital assistant (PDA), Moving Picture Expect Group (MPEG)-1 audio layer 3 (MP3) player, a kiosk, an electronic picture frame, a table, a display device, or the like. According to an embodiment, the user terminal device 200 may be referred to as the mobile device if implemented as a portable-type device such as, but not limited to, the mobile phone, the tablet PC, the PDA, the MP3 player, or the laptop PC. However, as used herein, the user terminal device 200 may collectively be referred to as the user terminal device 200.

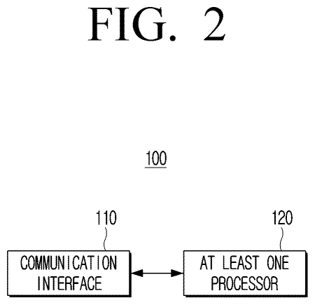

FIG. 2 is a block diagram showing a configuration of the electronic device, according to an embodiment of the present disclosure.

According to an embodiment of the present disclosure, the electronic device 100 may include a communication interface 110 and the at least one processor 120.

According to an embodiment, the communication interface 110 may be implemented as any of various interfaces, according to an implementation example of the electronic device 100. For example, the communication interface 110 may communicate with a plurality of robots, a charging station, or the like by using a communication method such as, but not limited to, Bluetooth™, access point (AP)-based wireless fidelity (Wi-Fi), Zigbee, wired and/or wireless local area network (LAN), wide area network (WAN), Ethernet, Institute of Electrical and Electronics Engineers 1394 (IEEE 1394 or FireWire), high-definition multimedia interface (HDMI), universal serial bus (USB), mobile high-definition link (MHL), audio engineering society/European broadcasting union (AES/EBU), optical communication, coaxial cable, or the like. As an example, the communication interface 110 may communicate with another electronic device, an external server, a remote control device, and/or the like.

According to an embodiment, the communication interface 110 may include a first communication interface and a second communication interface.

For example, the first communication interface may communicate with the user terminal device 200, the external server, or the like by using the wireless communication method such as Bluetooth™, AP-based Wi-Fi (and/or wireless LAN network), or the like, and the second communication interface may communicate with the external device (e.g., source device) by using the wired/wireless communication method such as, but not limited to, high-definition multimedia interface (HDMI), universal serial bus (USB), DisplayPort (DP), Thunderbolt (TB), or the like.

According to an embodiment, the at least one processor 120 may control overall operations of the electronic device 100. In particular, the at least one processor 120 may be connected to each component of the electronic device 100 and may control overall operations of the electronic device 100.

The at least one processor 120 may perform the operations of the electronic device 100, according to the various embodiments of the present disclosure, by executing at least one instruction stored in a memory.

The at least one processor 120 may include, but not be limited to, one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 120 may control one or any combination of other components of the electronic device and perform the operation related to the communication or data processing. The at least one processor 120 may execute at least one program or instruction stored in the memory. For example, the at least one processor 120 may perform a method, according to an embodiment of the present disclosure, by executing at least one instruction stored in the memory.

If the method, according to an embodiment of the present disclosure, includes a plurality of operations, the plurality of operations may be performed by one processor, or may be performed by a plurality of processors. For example, if a first operation, a second operation, and a third operation are performed by the method, according to an embodiment, the first operation, the second operation, and the third operation may all be performed by a first processor. Alternatively or additionally, the first operation and the second operation may be performed by the first processor (e.g., a general-purpose processor), and the third operation may be performed by a second processor (e.g., an artificial intelligence-only processor).

The at least one processor 120 may be implemented as a single-core processor including a single core, and/or may be implemented as at least one multi-core processor including multi-cores (e.g., homogeneous multi-cores or heterogeneous multi-cores). If the at least one processor 120 is implemented as the multi-core processor, each of the multi-cores included in the multi-core processor may include a processor internal memory such as, but not limited to, a cache memory or an on-chip memory, and a common cache shared by the multi-cores may be included in the multi-core processor. In addition, each (or some) of the multi-cores included in the multi-core processor may independently read and/or perform a program instruction for implementing the method, according to an embodiment of the present disclosure, and/or all (or some) of the multi-cores may be linked with each other to read and/or perform the program instruction for implementing the method, according to an embodiment of the present disclosure.

If the method, according to an embodiment of the present disclosure, includes the plurality of operations, the plurality of operations may be performed by the single core among the multi-cores included in the multi-core processor, or may be performed by the multi-cores. For example, if the first operation, the second operation, and the third operation are performed using the method, according to an embodiment, the first operation, the second operation, and the third operation may all be performed by a first core included in the multi-core processor. Alternatively or additionally, the first operation and the second operation may be performed by the first core included in the multi-core processor, and the third operation may be performed by a second core included in the multi-core processor.

In the embodiments of the present disclosure, the at least one processor 120 may be and/or may include a system-on-chip (SoC) in which the at least one processor 120 and/or other electronic components are integrated with each other, the single-core processor, the multi-core processor, or the core included in the single-core processor or the multi-core processor. Here, the core may be implemented as the CPU, the GPU, the APU, the MIC, the DSP, the NPU, the hardware accelerator, the machine learning accelerator, or the like. However, the embodiments of the present disclosure are not limited thereto.

According to an embodiment, the at least one processor 120 may receive a first Bluetooth™ low energy (BLE) packet and transmit a second BLE packet via the communication interface 110. For example, the at least one processor 120 may receive a first BLE advertising packet and transmit a second BLE advertising packet via the communication interface 110. Hereinafter, for convenience of description, the present disclosure may refer to the first BLE packet as the first BLE advertising packet, and the second BLE packet as the second BLE advertising packet. However, the present disclosure is not limited thereto, and the first BLE packet and the second BLE packet may refer to various other communication messages. According to an embodiment, the at least one processor 120 may communicate with the user terminal device 200 (e.g., a first user terminal device) that may output the first BLE advertising packet and display the notification (e.g., first notification) received by the user terminal device 200.

According to an embodiment, the notification may include a system message output by the user terminal device 200 to provide information to the user of the user terminal device 200.

For example, the user terminal device 200 may output a text message notification (e.g., a short message service (SMS) notification), a phone call notification, an application push notification, or the like as the notification.

For example, if a sender writes a text message and transmits the same to a short message service center (SMSC), the SMSC may route the text message written by the sender to a network to which a recipient (e.g., user terminal device 200) is connected. According to an embodiment, the user terminal device 200 may output the text message notification as the notification if the text message is received from a cell tower (or base station).

For example, the user terminal device 200 may receive a unique identifier (e.g., push token) for receiving the push notification if an application installed on the user terminal device 200 is registered with a push notification service (e.g., firebase cloud messaging (FCM) or Apple push notification service (APNs)) based on a user setting.

An application server (or a third-party service providing the application) may generate information (or an event) as the push notification and transmit the same to the user terminal device 200 based on the unique identifier. According to an embodiment, the user terminal device 200 may provide the push notification as the notification if the push notification is received from the application server.

According to an embodiment, the notification may include various forms and/or types of notifications for the user terminal device 200 to provide the information to the user, in addition to the text message notification (e.g., SMS), the phone call notification, and the application push notification.

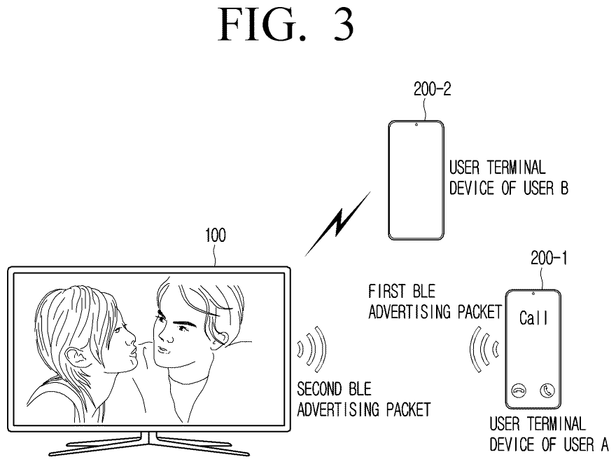

FIG. 3 is a diagram for describing the display device transmitting and receiving a Bluetooth™ low energy (BLE) advertising packet to and from a user terminal device, according to an embodiment of the present disclosure.

Referring to FIGS. 2 and 3, the at least one processor 120 may identify a first user terminal device 200-1 outputting (or broadcasting) the first BLE advertising packet based on identification information included in the first BLE advertising packet if the first BLE advertising packet is received via the communication interface 110.

According to an embodiment, the first BLE advertising packet may include identification information of the first user terminal device 200-1. For example, the identification information of the first user terminal device 200-1 may include the name, manufacturer information, universally unique identifier (UUID), or the like of the first user terminal device 200-1. The first BLE advertising packet may include the identification information based on an advertising data (AD) structure.

According to an embodiment, the first user terminal device 200-1 may output the first BLE advertising packet at a predetermined interval (e.g., millisecond (ms) interval).

According to an embodiment, the at least one processor 120 may control the communication interface 110 to output (or broadcast) the second BLE advertising packet if the first BLE advertising packet is received.

According to an embodiment, the at least one processor 120 may connect the electronic device 100 to the first user terminal device 200-1 if a connection request is received from the first user terminal device 200-1 and in response to the transmission of the second BLE advertising packet.

According to an embodiment, the at least one processor 120 may execute a hands-free functionality of displaying the first notification received by the first user terminal device 200-1. According to an embodiment, the hands-free functionality may include various hands-free functions.

According to an embodiment, the first user terminal device 200-1 may output the first notification, and the at least one processor 120 may execute the hands-free functionality to output the first notification to the electronic device 100.

Referring to FIG. 3, the at least one processor 120 may connect the electronic device 100 to a second user terminal device 200-2 and display a second notification received by the second user terminal device 200-2.

For example, the second user terminal device 200-2 may output the second notification, and the at least one processor 120 may execute the hands-free functionality to output the second notification to the electronic device 100.

The at least one processor 120 may receive the first BLE advertising packet output (or broadcast) by the first user terminal device 200-1 while connecting the electronic device 100 to the second user terminal device 200-2, and may display the first notification received by the first user terminal device 200-1 while connecting the electronic device 100 to the first user terminal device 200-1.

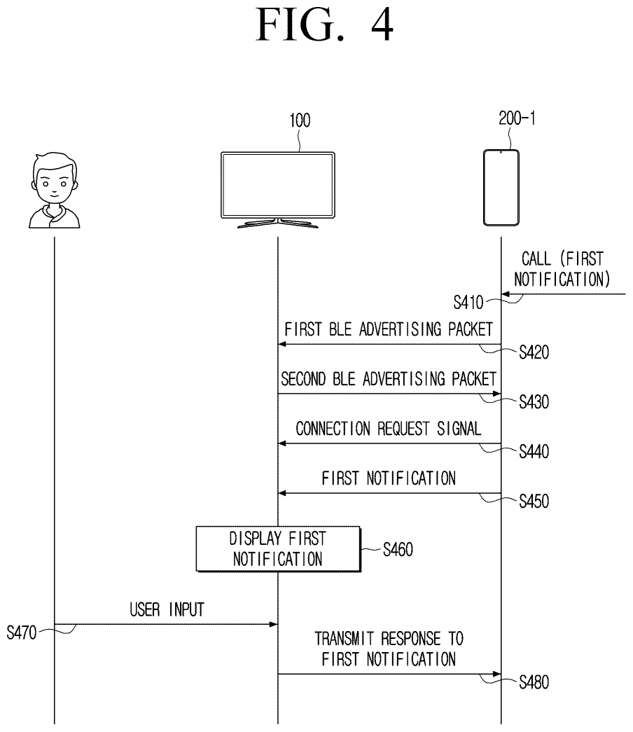

FIG. 4 is a sequence diagram for describing the display device displaying the notification received by the user terminal device, according to an embodiment of the present disclosure.

Referring to FIG. 4, the first user terminal device 200-1 may broadcast the first BLE advertising packet (operation S420) if the first user terminal device 200-1 receives the first notification (e.g., phone call) (operation S410).

According to an embodiment, the at least one processor 120 may broadcast the second BLE advertising packet if the first BLE advertising packet is received via the communication interface 110 (operation S430).

For example, the at least one processor 120 may identify the first user terminal device 200-1 based on the identification information of the first user terminal device 200-1 included in the first BLE advertising packet, and broadcast the second BLE advertising packet if the first user terminal device 200-1 is a pre-registered device (operation S430).

As another example, the at least one processor 120 may not broadcast the second BLE advertising packet if the first user terminal device 200-1 is an unregistered device.

According to an embodiment, the second BLE advertising packet may include identification information of the electronic device 100. For example, the identification information of the electronic device 100 may include the name, manufacturer information, universally unique identifier (UUID), or the like of the electronic device 100. The second BLE advertising packet may include the identification information based on the advertising data (AD) structure.

According to an embodiment, the first user terminal device 200-1 may transmit (e.g., unicast) the connection request signal to the electronic device 100 based on the identification information of the electronic device 100 included in the second BLE advertising packet (operation S440) if the second BLE advertising packet is received.

According to an embodiment, the at least one processor 120 may perform its connection with the first user terminal device 200-1 and receive data corresponding to the first notification (or information of the first notification) from the first user terminal device 200-1 (operation S450) if the connection request signal is received.

According to an embodiment, the at least one processor 120 may execute the hands-free functionality of displaying the first notification (operation S460) if the data corresponding to the first notification (or information of the first notification) is received (operation S450).

The at least one processor 120 may transmit, to the first user terminal device 200-1, a response (e.g., answering and/or rejecting the phone call, reading the message, replying to the message, or the like) to the first notification based on a user input (operation S480) if the user input for the first notification is received (operation S470).

According to an embodiment, the at least one processor 120 may output a sender voice received using the first user terminal device 200-1 at operation S480 and receive a user voice (e.g., a recipient voice) and transmit the same to the first user terminal device 200-1.

At operation S430 of FIG. 4, the at least one processor 120 may broadcast the second BLE advertising packet if the first user terminal device 200-1 is a pre-registered device, and may not broadcast the second BLE advertising packet if the first user terminal device 200-1 is an unregistered device. That is, the at least one processor 120 may execute the hands-free functionality of displaying the first notification only if the first user terminal device 200-1 is pre-registered to the electronic device 100 before receiving the first notification.

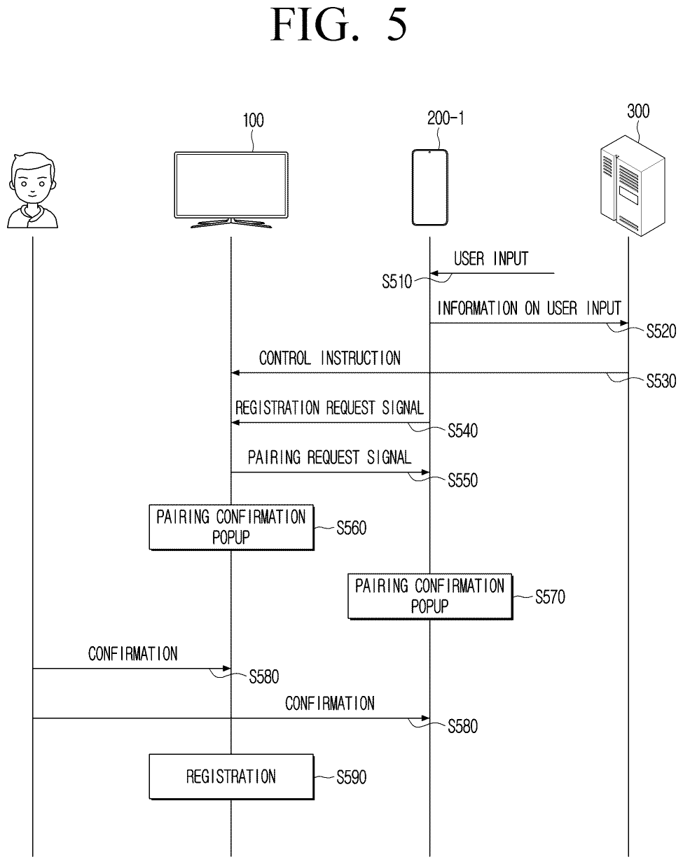

FIG. 5 is a sequence diagram for describing a method for registering the user terminal device to the display device, according to an embodiment of the present disclosure.

Operations S510 to S590 shown in FIG. 5 may include an initial setup operation that may be performed between the electronic device 100 and the first user terminal device 200-1 prior to operation S510.

According to an embodiment, the at least one processor 120 may determine the first user terminal device 200-1 to be a pre-registered device in operation S430 of FIG. 4. For example, the electronic device 100 and the first user terminal device 200-1 may be determined to be pre-registered to an account if the account logged into the electronic device 100 (or the account activated on the electronic device 100) and the account logged into the first user terminal device 200-1 (or the account activated on the first user terminal device 200-1) are the same as each other. That is, the account of the electronic device 100 matches the account of the first user terminal device 200-1.

According to an embodiment, the first user terminal device 200-1 may receive a user input for switching the hands-free functionality performed between the first user terminal device 200-1 and the electronic device 100 to an activated state (operation S510), and transmit information of the user input to an external server 300 (e.g., an account management server) if the account logged into the electronic device 100 and the account logged into the first user terminal device 200-1 are the same as each other. For example, at operation S510, the first user terminal device 200-1 may receive an instruction for activating the hands-free functionality performed between the first user terminal device 200-1 and the electronic device 100.

As another example, the first user terminal device 200-1 may receive a user input for activating its hands-free functionality (and/or call switching function) with the electronic device 100 pre-registered to the account through the application.

According to an embodiment, the external server 300 may transmit a control instruction for switching the hands-free functionality performed between the first user terminal device 200-1 and the electronic device 100 to the activated state based on the information of the electronic device 100 that is pre-registered to the account logged into the first user terminal device 200-1 (operation S530). For example, at operation S530, the external server 300 may transmit, to the electronic device 100, the instruction for executing the hands-free functionality performed between the first user terminal device 200-1 and the electronic device 100.

According to an embodiment, the at least one processor 120 may switch the hands-free functionality performed between the first user terminal device 200-1 and the electronic device 100 to the activated state based on the control instruction received from the external server 300 at operation S530. For example, the at least one processor 120 may execute the hands-free functionality performed between the first user terminal device 200-1 and the electronic device 100 based on the instruction received from the external server 300 at operation S530.

According to an embodiment, the first user terminal device 200-1 may receive the information of the electronic device 100 from the second user terminal device 200-2, which is logged in using the same account as the account logged into the electronic device 100, if the account logged into the electronic device 100 is different from the account logged into the first user terminal device 200-1.

According to an embodiment, the first user terminal device 200-1 may receive a user input for registering the first user terminal device 200-1 to the electronic device 100 based on the information of the electronic device 100 that is received from the second user terminal device 200-2 (operation S510).

For example, the first user terminal device 200-1 may receive the user input (e.g., user input for turning on the call switching function) for activating the hands-free functionality performed between the first user terminal device 200-1 and the electronic device 100 based on the information of the electronic device 100 that is received from the second user terminal device 200-2.

According to an embodiment, the first user terminal device 200-1 may transmit the information of the user input to the external server 300 (operation S520) if the user input for registering the first user terminal device 200-1 to the electronic device 100 is received (operation S510).

According to an embodiment, the external server 300 may transmit, to the electronic device 100, the control instruction for registering the first user terminal device 200-1 to the electronic device 100 pre-registered to an account logged into the second user terminal device 200-2 based on the information of the user input (operation S530). For example, the information of the user input may include the information of the electronic device 100 that is received from the second user terminal device 200-2 and the information of the user input for activating the hands-free functionality performed between the first user terminal device 200-1 and the electronic device 100.

According to an embodiment, the at least one processor 120 may switch the hands-free functionality performed between the first user terminal device 200-1 and the electronic device 100 to the activated state based on the control instruction received from the external server 300 at operation S530.

According to an embodiment, the first user terminal device 200-1 may transmit a registration request (or pairing request) to the electronic device 100 (operation S540). For example, the first user terminal device 200-1 may transmit a registration request signal (or pairing request signal) to the electronic device 100.

The at least one processor 120 may transmit the pairing request signal to the first user terminal device 200-1 based on the registration request signal received from the first user terminal device 200-1 (operation S550).

According to an embodiment, the at least one processor 120 may display a pairing confirmation popup (operation S560), and the first user terminal device 200-1 may also display the pairing confirmation popup (operation S570). As used herein, the pairing confirmation popup may be and/or may include a graphical and/or aural notification that may be seen and/or heard by the user that may indicate that a pairing request has been received and may request confirmation of the pairing request. For example, the pairing confirmation popup may include a graphical window containing text and/or images and may be displayed on top of other active graphical windows of the display. In an embodiment, the pairing confirmation popup may include graphical input components (e.g., a button, a check box, a text box, or the like) that the user may use to indicate confirmation (acceptance) and/or rejection of the pairing request.

The at least one processor 120 may register the first user terminal device 200-1 if a confirmation input is received for each of the pairing confirmation popup displayed by the electronic device 100 and the pairing confirmation popup displayed by the first user terminal device 200-1 (operation S580).

The present disclosure is not limited to the above-described examples, and the at least one processor 120 may register the first user terminal device 200-1 if the first user terminal device 200-1 is paired with the electronic device 100 in various ways.

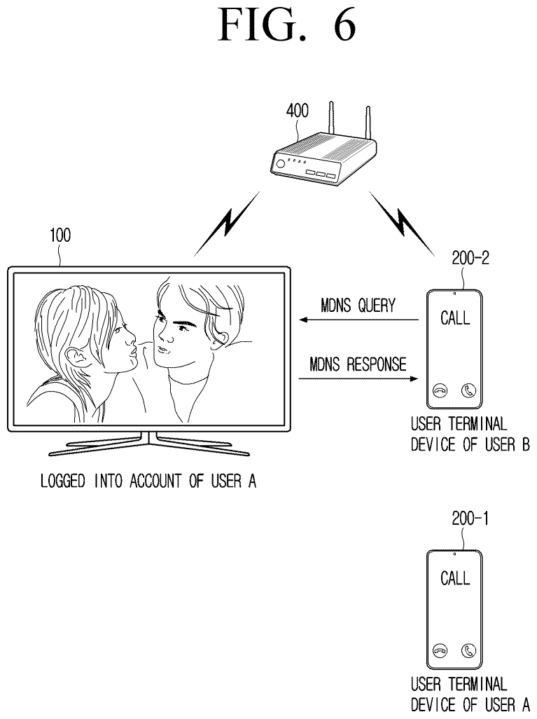

FIG. 6 is a diagram for describing the display device receiving a multicast domain name system (mDNS) query from the user terminal device and transmitting an mDNS response to the user terminal device, according to an embodiment of the present disclosure.

Referring to FIG. 6, each of the electronic device 100 and the second user terminal device 200-2 may be connected to an access point (AP) 400.

For example, the electronic device 100, the first user terminal device 200-1 of a user A, and the second user terminal device 200-2 of a user B may be connected to the access point installed in a home, respectively. However, the present disclosure is not limited in this regard. For example, the first user terminal device 200-1 and the second user terminal device 200-2 may be connected to a same network at other locations (e.g., a coffee shop, a restaurant, office and/or business premises, a public park, or the like).

According to an embodiment, the at least one processor 120 may display the first notification received by the first user terminal device 200-1 if the account logged into the electronic device 100 is an account of the user A.

In addition, the at least one processor 120 may display the first notification received by the first user terminal device 200-1 if the electronic device 100 and the first user terminal device 200-1 are currently connected to each other.

According to an embodiment of the present disclosure, the at least one processor 120 may connect the electronic device 100 to the second user terminal device 200-2 and display the second notification if the second user terminal device 200-2, logged in using an account (e.g., the account of the user B) that is different from the account (e.g., the account of the user A) logged into the electronic device 100, receives the second notification.

In addition, according to an embodiment of the present disclosure, the at least one processor 120 may connect the electronic device 100 to the second user terminal device 200-2 and display the second notification if the second user terminal device 200-2, which is not currently connected to the electronic device 100, receives the second notification.

According to an embodiment, the at least one processor 120 may control the communication interface 110 to transmit the mDNS response to the second user terminal device 200-2 if the mDNS query is received from the second user terminal device 200-2.

According to an embodiment, the at least one processor 120 may transmit the mDNS response, and then execute a hands-free functionality of displaying the second notification based on data corresponding to the second notification (or information of the second notification) if the data corresponding to the second notification (or information of the second notification) is received from the external server 300 in response to the transmission of the mDNS response.

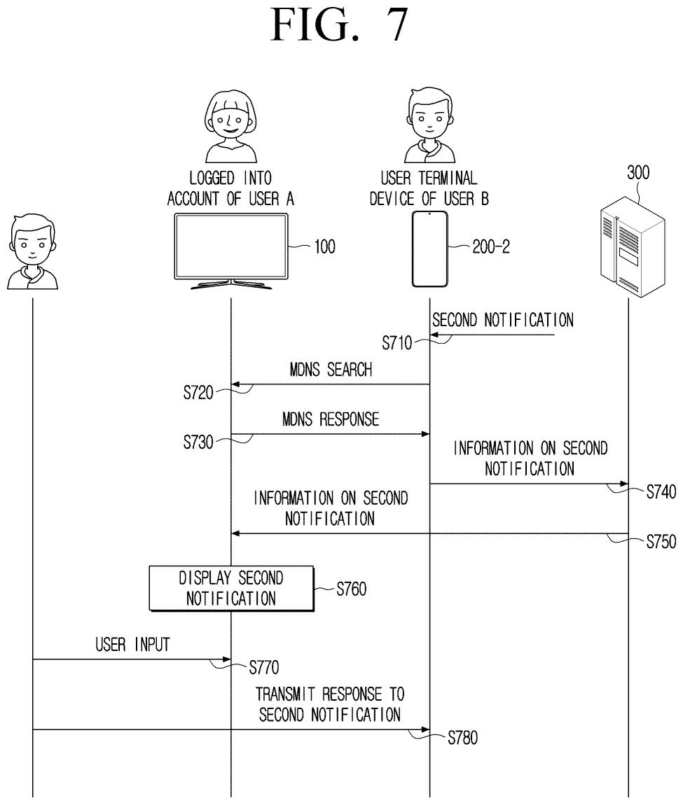

FIG. 7 is a sequence diagram for describing the display device displaying the notification received by the user terminal device that is logged in using the account different from the account logged into the display device, according to an embodiment of the present disclosure.

Referring to FIG. 7, the second user terminal device 200-2 may multicast the mDNS query to search for the electronic device 100 among the devices connected to the access point 400 (operation S720) if the second user terminal device 200-2 receives the second notification (operation S710).

According to an embodiment, the at least one processor 120 may multicast the mDNS response (operation S730) if the mDNS query is received. According to an embodiment, the at least one processor 120 may multicast the mDNS response including identification information of the second user terminal device 200-2.

According to an embodiment, the second user terminal device 200-2 may receive the mDNS response, and transmit the data corresponding to the second notification (or information of the second notification) to the external server 300 (operation S740) if the mDNS response includes the identification information of the second user terminal device 200-2.

According to an embodiment, the at least one processor 120 may execute the hands-free functionality of displaying the second notification (operation S760) if the data corresponding to the second notification (or information of the second notification) is received from the external server 300 (operation S750).

The at least one processor 120 may transmit, to the second user terminal device 200-2, a response (e.g., answering/rejecting the phone call, reading the message, or replying to the message) to the second notification based on a user input (operation S780) if the user input for the second notification is received (operation S770).

According to an embodiment, the at least one processor 120 may output the sender voice received using the second user terminal device 200-2 at operation S780 and receive the user voice (e.g., a recipient voice) and transmit the same to the second user terminal device 200-2.

As shown in FIG. 7, the account logged into the electronic device 100 may be the account of the user A, and the account logged into the second user terminal device 200-2 may be the account of the user B.

According to an embodiment of the present disclosure, the at least one processor 120 may connect the electronic device 100 to the second user terminal device 200-2 and display the second notification even if the second user terminal device 200-2, logged in using the account (e.g., the account of the user B) that is different from the account (e.g., the account of the user A) logged into the electronic device 100, receives the second notification.

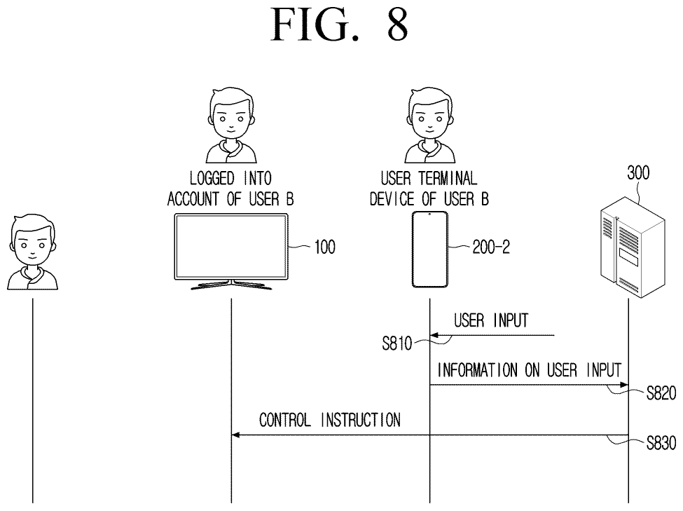

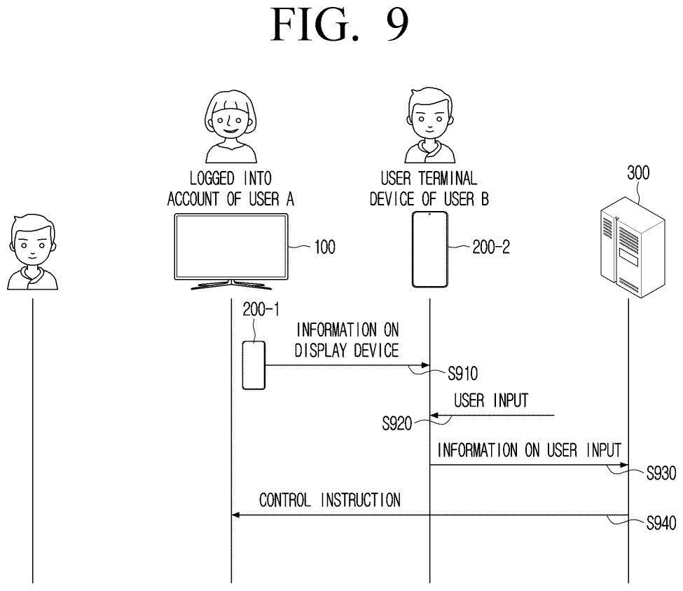

According to an embodiment, a method for multicasting the mDNS response including the identification information of the second user terminal device 200-2 in response to the reception of the mDNS query by the at least one processor 120 is described with reference to FIGS. 8 and 9.

FIG. 8 is a sequence diagram for describing a method for activating the hands-free functionality of the display device by using the user terminal device that is logged in using the same account as the account logged into the display device, according to an embodiment of the present disclosure.

Operations S810 to S830 shown in FIG. 8 may include an initial setup operation that may be performed between the electronic device 100 and the second user terminal device 200-2 prior to operation S810.

Referring to FIG. 8, the second user terminal device 200-2 may receive a user input for switching the hands-free functionality performed between the second user terminal device 200-2 and the electronic device 100 to the activated state (operation S810) because the electronic device 100 and the second user terminal device 200-2 may be pre-registered to the account if the account logged into the electronic device 100 (or the account activated on the electronic device 100) and the account logged into the second user terminal device 200-2 (or an account activated on the second user terminal device 200-2) are the same (e.g., the account of the user B).

According to an embodiment, the second user terminal device 200-2 may transmit the information of the user input to the external server 300 (operation S820) if the user input for switching the hands-free functionality performed between the second user terminal device 200-2 and the electronic device 100 to the activated state is received (operation S810).

According to an embodiment, the external server 300 may transmit, to the electronic device 100, a control instruction for switching the hands-free functionality performed between the second user terminal device 200-2 and the electronic device 100 to the activated state based on the information of the user input (operation S830). According to an embodiment, the control instruction may include the identification information of the second user terminal device 200-2.

As described with reference to FIG. 7, the at least one processor 120 may multicast information of the second user terminal device 200-2 that is included in the control instruction received at operation S830 by including the same in the mDNS response (operation S730).

FIG. 9 is a sequence diagram for describing a method for activating the hands-free functionality of the display device by using the user terminal device that is logged in using the account different from the account logged into the display device, according to an embodiment of the present disclosure.

Operations S910 to S940 shown in FIG. 9 may include the initial setup operation performed between the electronic device 100 and the second user terminal device 200-2 prior to operation S910.

Referring to FIG. 9, the account logged into the electronic device 100 (or the account activated on the electronic device 100) and the account logged into the second user terminal device 200-2 (or the account activated on the second user terminal device 200-2) may be different (e.g., the account logged into the electronic device 100 may be the account of the user A, and the account logged into the second user terminal device 200-2 may be the account of the user B).

According to an embodiment, the first user terminal device 200-1 may transmit the information of the electronic device 100 to the second user terminal device 200-2 (operation S910).

For example, the first user terminal device 200-1 may transmit the information of the electronic device 100 to the second user terminal device 200-2 in response to a request if the account logged into the first user terminal device 200-1 and the account logged into the electronic device 100 are the same (e.g., the account logged into the first user terminal device 200-1 is the account of the user A), and if the first user terminal device 200-1 receives the request for the information of the electronic device 100 from the second user terminal device 200-2.

According to an embodiment, the second user terminal device 200-2 may display a user interface (UI) for registering the second user terminal device 200-2 to the electronic device 100 and/or a UI for switching the hands-free functionality performed between the second user terminal device 200-2 and the electronic device 100 to the activated state, based on the information of the electronic device 100.

According to an embodiment, the second user terminal device 200-2 may receive the user input for the UI (e.g., user input for activating the hands-free functionality performed between the second user terminal device 200-2 and the electronic device 100) (operation S920).

According to an embodiment, the second user terminal device 200-2 may transmit the information of the user input to the external server 300 (operation S930) if the user input for switching the hands-free functionality performed between the second user terminal device 200-2 and the electronic device 100 to the activated state is received (operation S920). According to an embodiment, the second user terminal device 200-2 may transmit the information of the user input to the external server 300 (operation S930) if the user input for registering the second user terminal device 200-2 to the electronic device 100 is received (operation S920).

According to an embodiment, the external server 300 may transmit, to the electronic device 100, the control instruction for switching the hands-free functionality performed between the second user terminal device 200-2 and the electronic device 100 to the activated state based on the information of the user input (operation $940). According to an embodiment, the control instruction may include the identification information of the second user terminal device 200-2.

As described with reference to FIG. 7, at least one processor 120 may multicast the information of the second user terminal device 200-2 that is included in the control instruction received at operation S940 by including the same in the mDNS response (operation S730).

Referring back to FIG. 2, according to an embodiment of the present disclosure, the electronic device 100 may further include a memory.

According to an embodiment, the memory may store data necessary for the various embodiments of the present disclosure. The memory may be implemented in the form of a memory embedded in the electronic device 100 or in the form of a memory detachable from the electronic device 100, based on a data storage purpose.

For example, data for driving the electronic device 100 may be stored in the memory embedded in the electronic device 100, and data for an extension function of the electronic device 100 may be stored in the memory detachable from the electronic device 100.

The memory embedded in the electronic device 100 may be implemented as at least one of a volatile memory (e.g., a random access memory (RAM), a dynamic RAM (DRAM), a static RAM (SRAM), a synchronous DRAM (SDRAM), or the like) or a non-volatile memory (e.g., a read-only memory (ROM), a programmable ROM (PROM), an one time PROM (OTPROM), an erasable and programmable ROM (EPROM), an electrically erasable and programmable ROM (EEPROM), a mask ROM, or a flash ROM, a flash memory (e.g., a NAND flash or a NOR flash), a hard disk drive (HDD), a solid state drive (SSD), or the like).

The memory detachable from the electronic device 100 may be implemented in the form of a memory card (e.g., compact flash (CF), secure digital (SD), micro secure digital (Micro-SD), mini secure digital (Mini-SD), extreme digital (xD), or multi-media card (MMC)), an external memory which may be connected to a universal serial bus (USB) port (e.g., a USB memory), or the like. However, the present disclosure is not limited in this regard.

According to an embodiment, the memory may store at least one instruction for controlling the electronic device 100 or a computer program including this instruction.

According to an embodiment of the present disclosure, the electronic device 100 may further include a microphone.

According to an embodiment, the at least one processor 120 may receive a voice signal through the microphone and may identify the user input corresponding to the voice signal. According to an embodiment, the electronic device 100 may also receive the voice signal via a remote control or the microphone installed in the user terminal device 200.

For example, the at least one processor 120 may broadcast the BLE advertising packet based on the voice signal received through the microphone if the user input for activating its hands-free functionality (or call switching function) with the first user terminal device 200-1 is identified.

According to an embodiment, the at least one processor 120 may pair the electronic device 100 with the first user terminal device 200-1 and register the first user terminal device 200-1 (e.g., register the first user terminal device 200-1 to the account logged into the display device if the connection request signal (e.g., pairing request signal) is received from the first user terminal device 200-1 in response to the broadcast of the BLE advertising packet.

According to an embodiment, the electronic device 100 may display the first notification (operation S460), and transmit the response to the first notification to the first user terminal device 200-1 (operation S480) if the first user terminal device 200-1 receives the first notification (operation S410 in FIG. 4), even though the at least one processor 120 of the electronic device 100 may be connected to the second user terminal device 200-2 instead of the first user terminal device 200-1.

According to an embodiment, the electronic device 100 may be implemented as an electronic device such as, but not limited to, a set-top box, a cloud server, an over-the-top media service (OTT) server, a streaming service (e.g., Samsung Gaming Hub™), a home automation control panel, a security control panel, a media box (e.g., Samsung HomeSync™, AppleTV™, or Google TV™), a game console (e.g., Microsoft Xbox™, Sony PlayStation™, or Nintendo Switch™), an electronic dictionary, an electronic key, a camcorder, an electronic picture frame, a TV, or the like. However, the electronic device 100 is not limited thereto, and may be and/or may include at least one of a TV, a user terminal device, a tablet PC, a mobile phone, a video phone, an e-book reader, a desktop PC, the laptop PC, a netbook computer, a workstation, a server, the PDA, a portable multimedia player (PMP), the MP3 player, a medical device, a camera, a virtual reality (VR) implementation device, a spatial computing device, or a wearable device. As used herein, the wearable device may be and/or may include at least one of an accessory type wearable device (e.g., a watch, a ring, a bracelet, an anklet, a necklace, a glasses, a contact lens, or a head-mounted-device (HMD), a textile or clothing integral type wearable device (e.g., an electronic clothing), a body attachment type wearable device (e.g., a skin pad or a tattoo), or a living body implantation type wearable device (e.g., an implantable circuit).

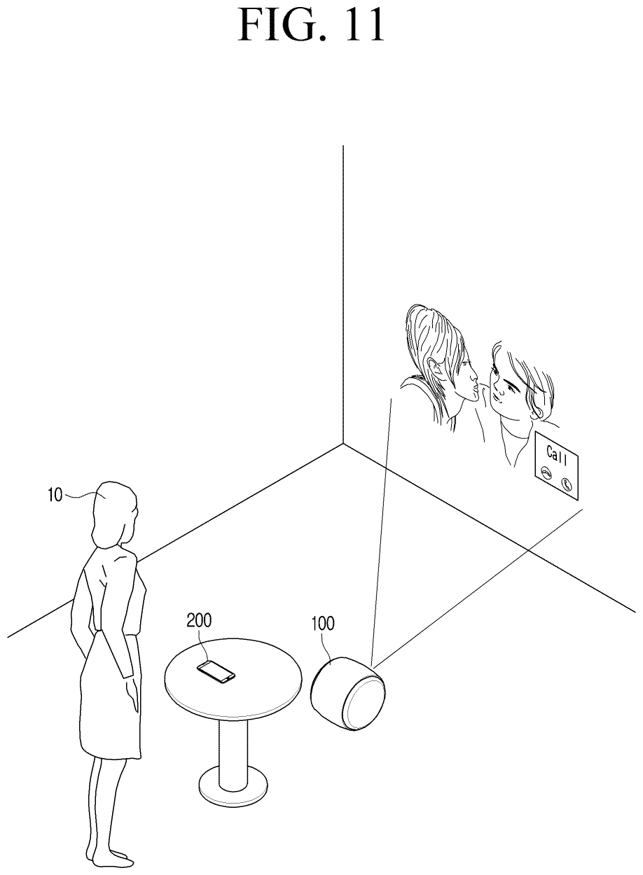

According to an embodiment, the electronic device 100 may be implemented as a mobile robot, and the mobile robot may include a display (e.g., projector display), as described with reference to FIG. 11.

According to an embodiment, the mobile robot may identify a location of each of the plurality of users within a home by using a sensor (e.g., a camera).

According to an embodiment, the mobile robot may move (e.g., travel using self-locomotion or be propelled and/or relocated) to a location of the user A within the home and display the first notification if the first user terminal device 200-1 corresponding to the user A among the plurality of users receives the first notification.

For example, the at least one processor 120 may display the first notification, as described with reference to operations S420 to S450 of FIG. 4, after the mobile robot moves to the location of the user A within the home (operation S460) if the first user terminal device 200-1, logged in using the account of the user A, receives the first notification (operation S410 in FIG. 4).

As another example, the at least one processor 120 may display the second notification, as described with reference to operations S720 to S750 of FIG. 7, after the mobile robot moves to the location of the user B within the home (operation S760) if the second user terminal device 200-2, logged in using the account of the user B, receives the second notification (operation S710 in FIG. 7).

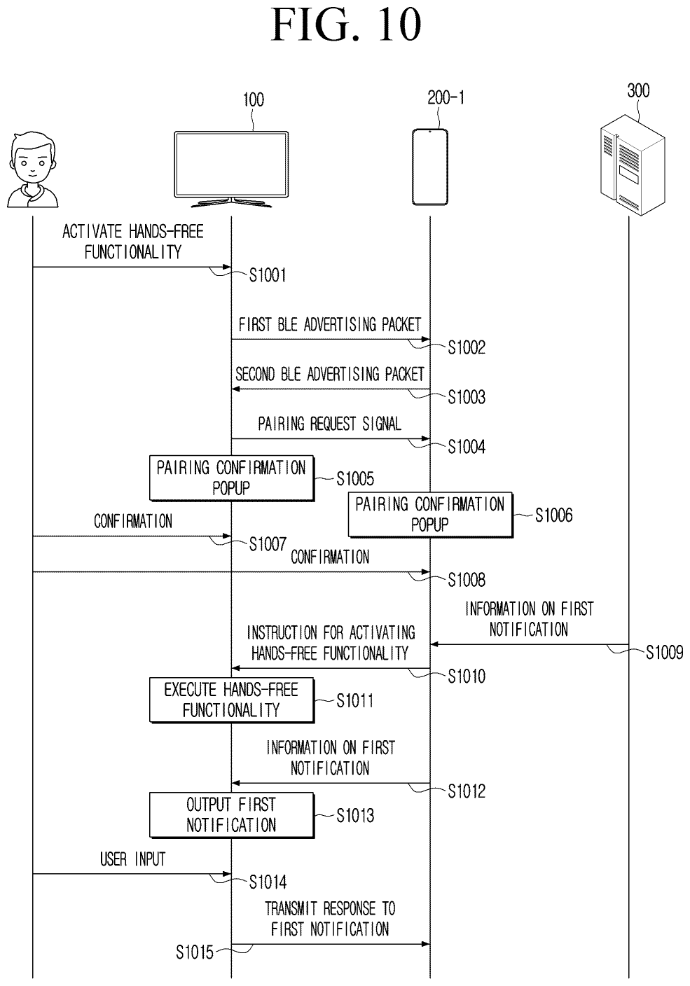

FIG. 10 is a sequence diagram for describing a method for activating the hands-free functionality of the display device, according to an embodiment of the present disclosure.

According to an embodiment, the at least one processor 120 may activate (or execute) the hands-free functionality of the display device in response to the instruction (e.g., user input) for activating the hands-free functionality (operation S1001).

According to an embodiment, the at least one processor 120 may output (or broadcast) the first BLE advertising packet (operation S1002), and the first user terminal device 200-1, which receives the first BLE advertising packet output by the electronic device 100, may output the second BLE advertising packet (operation $1003).

According to an embodiment, the at least one processor 120 may transmit the pairing request signal to the first user terminal device 200-1 if the second BLE advertising packet output by the first user terminal device 200-1 is received (operation S1004).

According to an embodiment, the electronic device 100 and the first user terminal device 200-1 may respectively output the pairing confirmation popup (operations S1005 and S1006).

According to an embodiment, the at least one processor 120 may complete the pairing between the electronic device 100 and the first user terminal device 200-1 if the confirmation for the pairing confirmation popup output by the electronic device 100 is input (operation S1007) and if the confirmation for the pairing confirmation popup output by the first user terminal device 200-1 is input (operation S1008).

For example, the at least one processor 120 may register the first user terminal device 200-1 to execute the hands-free functionality performed between the electronic device 100 and the first user terminal device 200-1.

According to an embodiment, the first user terminal device 200-1 may transmit, to the electronic device 100, the instruction for activating the hands-free functionality of the electronic device 100 (operation S1010) if the first user terminal device 200-1 receives the information of the first notification (or data corresponding to the first notification) from the server 300 (operation S1009).

According to an embodiment, the at least one processor 120 may execute the hands-free functionality if the instruction for activating the hands-free functionality is received (operation S1011).

In an embodiment, the at least one processor 120 may ignore (or reject) the instruction for activating the hands-free functionality if the hands-free functionality is already being executed.

According to an embodiment, the at least one processor 120 may output the first notification (operation S1013) if the information of the first notification (or data corresponding to the first notification) is received from the first user terminal device 200-1 (operation S1012).

According to an embodiment, the at least one processor 120 may transmit the response to the first notification to the server 300 (operation S1015) if the user input for the first notification (e.g., user input for responding to the first notification (e.g., receiving, replying, or confirming the same)) is received (operation S1014).

According to an embodiment, the at least one processor 120 may respond to the first notification by transmitting the user input for the first notification to the first user terminal device 200-1. For example, the user may respond to the first notification intended to be output to the first user terminal device 200-1 without directly touching (or manipulating) the first user terminal device 200-1.

As another example, if the first notification is the text message notification (short message service), the at least one processor 120 of the electronic device 100 may control the first user terminal device 200-1 to display the text message or transmit a response (or reply) corresponding to the text message to the sender based on the user input.

As another example, the first notification may be a phone call notification. In such an example, if the at least one processor 120 of the electronic device 100 responds to the phone call notification based on the user input, the at least one processor 120 may control the first user terminal device 200-1 to transmit, to the sender, the user input (e.g., user voice) received through the microphone installed in the electronic device 100 or may output the sender voice through a speaker installed in the electronic device 100. However, the present disclosure is not limited thereto, and the at least one processor 120 may control the first user terminal device 200-1 to reject the phone call notification based on the user input.

In an embodiment, the at least one processor 120 may control the first user terminal device 200-1 to operate the application based on the user input for the application push notification if the first notification is the application push notification.

FIG. 11 is a diagram for describing the display device, according to an embodiment of the present disclosure.

Referring to FIG. 11, according to an embodiment, the electronic device 100 may be implemented as a mobile robot including the display (e.g., projector display). For example, the mobile robot may include a drive device including a motor, wheels, brakes, or the like, and may be moved by itself (e.g., self-propelled) within a space (e.g., within a home) by using the drive device. According to an embodiment, the mobile robot may perform a simultaneous localization and mapping (SLAM) operation, and as such, may acquire map information corresponding to the space, and identify a location of the mobile robot and the location of the user (e.g., user A) within the space.

According to an embodiment, the mobile robot may include the projector display, and execute the hands-free functionality to output, onto a projection surface, the first notification intended to be output to the first user terminal device 200-1 or the second notification intended to be output to the second user terminal device 200-2.

According to an embodiment, the projection surface may be a part of a physical space for outputting an image (e.g., any of various types of images including the first notification or the second notification), and/or may be a separate screen. For example, the projection surface may include a wall surface, a floor surface, or the like, and may be adjacent (e.g., within viewing distance) to the user.

According to an embodiment, the mobile robot may include a pan, tilt, and zoom (PTZ) motor and may output the image onto the projection surface by appropriately controlling the PTZ motor. In an embodiment, the PTZ motor may include a motor capable of being rotated in a pan direction (e.g., horizontal direction or left and right direction) and/or a motor capable of being rotated in a tilt direction (e.g., vertical direction or up and down direction).

According to an embodiment, the mobile robot may output the image by performing lens shift, color matching, edge blending, keystone correction, leveling correction (horizontal correction), focus correction, or the like.

For example, the at least one processor 120 of the mobile robot may perform the keystone correction to enable the image (e.g., the first notification or the second notification) to have a rectangular or square shape if the image is trapezoidal. For example, the at least one processor 120 of the mobile robot may perform a leveling correction by rotating an image angle to make the image horizontal. As another example, the at least one processor 120 of the mobile robot may perform a focus correction to bring the image into focus, based on, for example, a distance between the mobile robot and the projection surface.

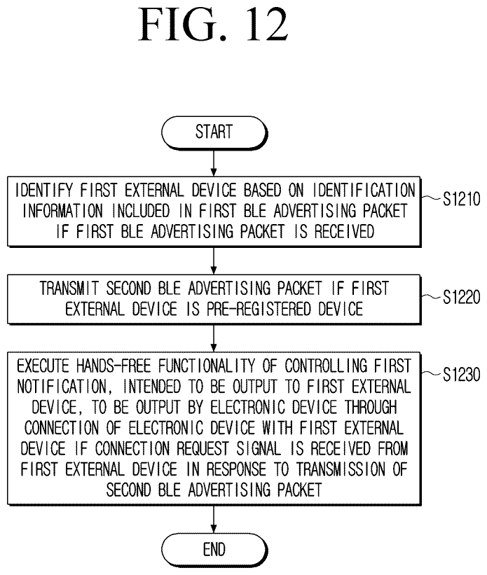

FIG. 12 is a flowchart for describing a control method of a display device, according to an embodiment of the present disclosure.

According to an embodiment of the present disclosure, the control method of an electronic device may include identifying the first user terminal device based on the identification information included in the first BLE advertising packet if the first BLE advertising packet is received (operation S1210).

The control method may include transmitting the second BLE advertising packet if the first user terminal device is the pre-registered device (operation S1220).

The control method may include executing the hands-free functionality of displaying the first notification received by the first user terminal device through the connection of the electronic device with the first user terminal device if the connection request signal is received from the first user terminal device in response to the transmission of the second BLE advertising packet (operation S1230).

The control method, according to an embodiment of the present disclosure, may further include switching the hands-free functionality of the electronic device with the second user terminal device to the activated state if the control instruction for switching the hands-free functionality of the electronic device with the second user terminal device to the activated state is received from the external server, in which the electronic device displays the second notification intended to be output to the second user terminal device (or the second notification received by the second user terminal device), and registering the second user terminal device by pairing the electronic device with the second user terminal device if the registration request signal is received from the second user terminal device.

A control method, according to an embodiment of the present disclosure, may further include displaying a third notification received by a third user terminal device if the third user terminal device being connected to the electronic device receives the third notification, and the executing of the hands-free functionality (operation S1230) may include executing the hands-free functionality of displaying the first notification received by the first user terminal device if the connection request signal is received from the first user terminal device.

The first user terminal device, according to an embodiment of the present disclosure, may transmit the first BLE advertising packet if the first notification is received.

The control method, according to an embodiment of the present disclosure, may further include transmitting the mDNS response to the second user terminal device if the multicast DNS (mDNS) query is received from the second user terminal device, and executing the hands-free functionality of displaying (or outputting) the second notification based on the data corresponding to the second notification (or information of the second notification) if the data corresponding to the second notification (or information of the second notification) is received by the second user terminal device from the external server in response to the transmission of the mDNS response. The second user terminal device may transmit the data corresponding to the second notification (or information of the second notification) to the external server to enable the data to be transmitted to the electronic device if the mDNS response includes the identification information of the second user terminal device.

The second user terminal device, according to an embodiment of the present disclosure, may transmit the mDNS query if the second notification is received.

The control method, according to an embodiment of the present disclosure, may further include switching the hands-free functionality of the electronic device with the second user terminal device to the activated state if the control instruction for activating the hands-free functionality of the electronic device with the second user terminal device is received from the external server. The control instruction may include the identification information of the second user terminal device.

In the switching of the hands-free functionality of the electronic device with the second user terminal device to the activated state, according to an embodiment of the present disclosure, the control instruction corresponding to the user input for switching the hands-free functionality to the activated state may be received by the electronic device pre-registered to the account logged into the second user terminal device if the account logged into the electronic device and the account logged into the second user terminal device are the same as each other.

In the switching of the hands-free functionality of the electronic device with the second user terminal device to the activated state, according to an embodiment of the present disclosure, the control instruction corresponding to the user input for switching the hands-free functionality to the activated state may be received by the electronic device based on the information of the electronic device that is pre-registered to the account logged into the first user terminal device if the account logged into the electronic device and the account logged into the second user terminal device are different from each other, the information of the electronic device being transmitted from the first user terminal device to the second user terminal device, and the account logged into the electronic device and the account logged into the first user terminal device being the same as each other.

The executing of the hands-free functionality (operation S1230), according to an embodiment of the present disclosure, may include displaying the first notification based on the hands-free functionality, and controlling the first user terminal device to transmit the response to the first notification based on the user input for the first notification.

However, the various embodiments of the present disclosure may be applied not only to the electronic device but also to various types of electronic devices, each of which may include a display.

The various embodiments of the present disclosure described above may be implemented in a recording medium readable by a computer or similar device using software, hardware, or a combination thereof. In some cases, the embodiments described in the present disclosure may be implemented by the processor itself. In a software implementation, the embodiments such as the procedures and functions described in the present disclosure may be implemented by separate software modules. Each of the software modules may perform one or more functions and operations described in the present disclosure.

A non-transitory computer-readable medium may store computer instructions for performing processing operations of the electronic device, according to various embodiments of the present disclosure. The computer instructions stored in the non-transitory computer-readable medium may allow a specific device to perform the processing operations of the electronic device, according to various embodiments, if executed by a processor of the specific device.

The non-transitory computer-readable medium indicates a medium that semi-permanently stores data therein and is readable by the machine instead of a medium that stores data therein temporarily, such as a register, a cache, or a memory. Examples of the non-transitory computer-readable medium may include, but may not be limited to, a compact disk (CD), a digital versatile disk (DVD), a hard disk, a Blu-ray disk, a universal serial bus (USB), a memory card, a read only memory (ROM), or the like.

Although various embodiments are shown and described in the present disclosure, the present disclosure is not limited to the above-described specific embodiments, and may be variously modified by those skilled in the art to which the present disclosure pertains without departing from the scope of the present disclosure as claimed in the accompanying claims. These modifications should also be understood to fall within the scope and spirit of the present disclosure.

What is claimed is:

1. An electronic device comprising:
a communication interface;
one or more processors comprising processing circuitry; and
memory storing instructions,
wherein the instructions, when executed by the one or more processors individually or collectively, cause the electronic device to:
identify a first external device based on identification information included in a first Bluetooth low energy (BLE) packet based on the first BLE packet received through the communication interface;
transmit, through the communication interface, a second BLE packet based on the identification of the first external device as a pre-registered device;
based on a connection request being received from the first external device through the communication interface according to the transmission of the second BLE packet, perform a first connection between the electronic device and the first external device; and
execute a first hands-free functionality of controlling a first notification, intended to be output by the first external device, to be output by the electronic device, based on the first connection of the electronic device with the first external device.

2. The electronic device of claim 1, wherein the instructions, when executed by the one or more processors individually or collectively, further cause the electronic device to:
based on a control instruction instructing to activate a second hands-free functionality of the electronic device with a second external device received from a server through the communication interface, perform a second connection between the electronic device and the second external device;
execute the second hands-free functionality of controlling a second notification, intended to be output by the second external device, to be output by the electronic device, based on the second connection of the electronic device with the second external device; and
register, based on a registration request received from the second external device through the communication interface, the second external device by pairing the electronic device with the second external device.

3. The electronic device of claim 1, wherein the instructions, when executed by the one or more processors individually or collectively, further cause the electronic device to:
execute a third hands-free functionality of controlling the electronic device to output a third notification intended to be output by a third external device, based on the third external device, being connected to the electronic device via the communication interface, receiving data corresponding to the third notification intended to be output to the third external device.

4. The electronic device of claim 1, wherein the first external device is configured to transmit the first BLE packet based on data corresponding to the first notification received.

5. The electronic device of claim 1, wherein the instructions, when executed by the one or more processors individually or collectively, further cause the electronic device to:
based on an mDNS query being received from a second external device, transmit, to the second external device through the communication interface, a multicast domain name system (mDNS) response comprising second identification information of the second external device;
based on receiving data corresponding to a second notification, received by the second external device from a server in response to the transmission of the mDNS response, execute a second hands-free functionality of controlling the electronic device to output the second notification based on the data corresponding to the second notification; and
wherein the second external device is configured to transmit the data corresponding to the second notification to the server to enable the data corresponding to the second notification to be transmitted to the electronic device.

6. The electronic device of claim 5, wherein the second external device is configured to transmit the mDNS query to the electronic device based on the data corresponding to the second notification received.

7. The electronic device of claim 5, wherein the instructions, when executed by the one or more processors individually or collectively, further cause the electronic device to:
execute the second hands-free functionality of the electronic device with the second external device based on a control instruction for activating the second hands-free functionality with the second external device received from the server; and
wherein the control instruction including the identification information of the second external device.

8. The electronic device of claim 7, wherein the instructions, when executed by the one or more processors individually or collectively, further cause the electronic device to:
enable the electronic device, pre-registered to a second account logged into the second external device, to receive the instruction corresponding to a user input for activating the second hands-free functionality of the electronic device with the second external device based on a first account logged into the electronic device matching the second account.

9. The electronic device of claim 7, wherein instructions, when executed by the one or more processors individually or collectively, further cause the electronic device to:
enable the electronic device to receive the instruction corresponding to a user input for activating the first hands-free functionality, based on information of the electronic device being pre-registered to a first account logged into the first external device, and based on a third account logged into the electronic device being different from a second account logged into the second external device,
wherein the information of the electronic device has been transmitted from the first external device to the second external device, and
wherein the third account matches the first account.

10. The electronic device of claim 1, wherein the instructions, when executed by the one or more processors individually or collectively, further cause the electronic device to:
transmit, to the first external device using the communication interface, a response to the first notification based on a user input corresponding to the first notification.

11. A control method of an electronic device, the control method comprising:
identifying a first external device based on identification information included in a first Bluetooth low energy (BLE) packet based on the first BLE packet received;
transmitting, to the first external device, a second BLE packet based on identifying the first external device as a pre-registered device;
based on a connection request being received from the first external device, according to the transmitting of the second BLE packet, performing a first connection between the electronic device and the first external device; and
executing a first hands-free functionality of controlling a first notification, intended to be output by the first external device, to be output by the electronic device based on the first connection of the electronic device with the first external device.

12. The control method of claim 11, further comprising:
based on a control instruction instructing to activate a second hands-free functionality of the electronic device with a second external device received from a server, performing a second connection between the electronic device and the second external device;
executing the second hands-free functionality of controlling a second notification, intended to be output by the second external device, to be output by the electronic device, based on the second connection of the electronic device with the second external device; and
registering, based on a registration request received from the second external device, the second external device by pairing the electronic device with the second external device.

13. The control method of claim 11, further comprising:
executing a third hands-free functionality of controlling the electronic device to output a third notification intended to be output by a third external device to be output by the electronic device, based on the third external device, being connected to the electronic device, receiving data corresponding to the third notification intended to be output to the third external device.

14. The control method of claim 11, wherein the first BLE packet is transmitted by the first external device based on data corresponding to the first notification received.

15. A non-transitory computer-readable storage medium storing a computer-readable instruction that, when executed by one or more processors of an electronic device, causes the electronic device to:
identify a first external device based on identification information included in a first Bluetooth low energy (BLE) packet based on the first BLE packet received,
transmit a second BLE packet based on the identification of the first external device as a pre-registered device;
based on a connection request being received from the first external device according to the transmission of the second BLE packet, perform a connection between the electronic device and the first external device; and
execute a hands-free functionality of controlling a notification intended to be output by the first external device, to be output by the electronic device based on the connection of the electronic device with the first external device.

16. The non-transitory computer-readable storage medium of claim 15, wherein the instructions, when executed by the one or more processors individually or collectively, further cause the electronic device to:
based on a control instruction instructing to activate a second hands-free functionality of the electronic device with a second external device received from a server, perform a second connection between the electronic device and the second external device;
execute the second hands-free functionality of controlling a second notification, intended to be output by the second external device, to be output by the electronic device, based on the second connection of the electronic device with the second external device; and
register, based on a registration request received from the second external device, the second external device by pairing the electronic device with the second external device.

17. The non-transitory computer-readable storage medium of claim 15, wherein the instructions, when executed by the one or more processors individually or collectively, further cause the electronic device to:
execute a third hands-free functionality of controlling the electronic device to output a third notification intended to be output by a third external device, based on the third external device, being connected to the electronic device, receiving data corresponding to the third notification intended to be output to the third external device.

18. The non-transitory computer-readable storage medium of claim 15, wherein the first external device is configured to transmit the first BLE packet based on data corresponding to a first notification being received.

19. The non-transitory computer-readable storage medium of claim 15, wherein the instructions, when executed by the one or more processors individually or collectively, further cause the electronic device to:
based on an mDNS query being received from a second external device, transmit, to the second external device, a multicast domain name system (mDNS) response comprising second identification information of the second external device;
based on receiving data corresponding to a second notification, received by the second external device from a server in response to the transmission of the mDNS response, execute a second hands-free functionality of controlling the electronic device to output the second notification based on the data corresponding to the second notification; and
wherein the second external device is configured to transmit the data corresponding to the second notification to the server to enable the data corresponding to the second notification to be transmitted to the electronic device.

20. The non-transitory computer-readable storage medium of claim 19, wherein the second external device is configured to transmit the mDNS query to the electronic device based on the data corresponding to the second notification received.
